(19) United States
(12) Patent Application Publication
(10) Pub. No.: US 2021/0289715 A1
(43) Pub. Date: Sep. 23, 2021

(54) PLANT TERRARIUM ASSEMBLY WITH A REMOVABLE RETAINER

(71) Applicant: PIKAPLANT B.V., Amsterdam (NL)

(72) Inventors: Daniel Indra SUTJAHJO, Amsterdam (NL); Joost Cornelis VAN UDEN, Amsterdam (NL); Javier PEDRO FERRER, Amsterdam (NL); Carmel ATTIA, Amsterdam (NL)

(21) Appl. No.: 16/339,578

(22) PCT Filed: Oct. 6, 2017
(86) PCT No.: PCT/NL2017/050660

§ 371 Date: Apr. 4, 2019

(30) Foreign Application Priority Data
Oct. 7, 2016 (NL) 2017591

(51) Int. Cl. A01G 9/08

(52) U.S. Cl. CPC A01G 9/088; A01K 63/003

(57) ABSTRACT

The present invention relates to a plant terrarium assembly for containing a plant, the plant terrarium assembly comprising an at least partially transparent housing enclosing an inner volume, the transparent housing comprising a top side, and an opening defined by a rim, a closing member configured to be moved between a closed position and an open position in order to open and close the opening in the housing, wherein the closing member has an inner side and an outer side, wherein in the closed position the inner side faces the inner volume, and wherein the outer side is configured to form a bottom side of the plant terrarium assembly and to be placed on a base surface.

### FIELD OF THE INVENTION

The present invention relates to a plant terrarium assembly. The present invention further relates to a removable retainer for maintaining structural integrity of the plant terrarium assembly during transport. The present invention further relates to a method of assembling the plant terrarium assembly and to a method of removing a removable retainer from the plant terrarium assembly.

### BACKGROUND OF THE INVENTION

During transport of items it more often than not occurs that an item is placed in a random orientation. Ideally an item is transported bottom down in its natural orientation. However, due to human error items are often placed on their side or upside down.

A plant terrarium assembly is essentially a terrarium which holds a plant. The plant is positioned in a container which in itself is positioned inside the terrarium. The container may be a simple pot. The plant terrarium assembly is known. The terrarium not only serves as a packaging, but after delivery on site the plant stays in the terrarium. Because the terrarium is closed, the water does not evaporate from the terrarium and the plant can still live and even grow without adding water. The container contains a growing medium and nutrients for the plant.

It was found that transporting the plant terrarium assembly in an orientation other than the desired orientation may lead to a broken product. Transporting it upside down may cause the growing medium and/or plant to fall out of the container, or even cause the container to disconnect from the terrarium in case the container is not integrally connected with the terrarium.

In the present invention it was recognized that during transportation of the plant terrarium assembly the container containing a growing medium and a plant need to be retained such that also the growing medium and plant are maintained in the container.

As the plant terrarium assembly in itself is a unique product, there are no known solutions for this problem.

Moreover, it was recognized that a primary benefit of the plant terrarium assembly is its unique visual appeal. Any solution to the problem of damage during transport should not adversely affect this unique visual appeal. Moreover, it was recognized that any solution to the transport problem should also not disadvantageously affect the characteristics of a closed terrarium which allows the plant to live and grow without adding water or nutrients.

### OBJECT OF THE INVENTION

It is an object of the invention to provide a plant terrarium assembly that can be transported safely while maintaining structural integrity of the product, and while avoiding any disadvantageous effect on its visual appeal.

It is yet another objective to provide a removable retainer that can be easily removed.

### SUMMARY OF THE INVENTION

The invention provides a plant terrarium assembly comprising:
an at least partially transparent housing enclosing an inner volume, the transparent housing comprising a top side, and an opening defined by a rim,
a closing member configured to be moved between a closed position and an open position in order to open and close the opening in the housing, wherein the closing member has an inner side and an outer side, wherein in the closed position the inner side faces the inner volume, and wherein the outer side is configured to form a bottom side of the plant terrarium assembly,
a container comprising a lower end and an open upper end, wherein the container is supported by the inner side of the closing member,
a growing medium and at least one plant which are positioned in the container,
a removable retainer configured to keep the growing medium in the container during transport.

The removable retainer holds the growing medium in the container during transport and holds the container in position in case the closing member and container are not integrally connected. After delivery, the removable retainer can be removed through the opening of the terrarium. This prevents any disadvantageous effect on the visual appearance of the plant terrarium assembly.

The growing medium may be soil, rockwool, clay pebbles, hydrogel, glasswool or another medium.

The plant terrarium may be a closed plant terrarium. The plant terrarium may be a jar, in particular a glass jar.

In an embodiment, the plant terrarium assembly is configured to be an airtight, enclosed ecosystem.

In an embodiment, the removable retainer is an elongate strip of a flexible material, in particular paper, cardboard or a plastic material.

In an embodiment, a central portion of the elongate strip extends over the open upper end of the container.

In an embodiment, opposite first and second ends of the elongate strip extend to outside the housing.

In an embodiment, the opposite first and second end portions of the elongate strip are wedged between the closing member which is in the closed position and the housing.

In an embodiment, the removable retainer has a first length L1 which is at least equal to:
the diameter D1 of the container, plus
twice the distance from a first edge of the closing member to a second edge of the open upper end of the container.

In an embodiment, the removable retainer has a length L2 which is at least equal to:
the diameter D of the container, plus
the diameter of the closing member, plus
twice the distance from a first edge of the closing member to a second edge of the open upper end of the container.

In an embodiment, the central portion is wider than the first and second opposite end portions.

In an embodiment, the central portion comprises folded portions which extend into the open upper end of the container and engage the growing medium, directly or indirectly, in order to keep the growing medium in place.

In an embodiment, the removable retainer has an opening and closing means at the first and second opposite ends, wherein the opening and closing means are configured to attach the ends of the retainer to one another outside the housing.

In an embodiment, the removable retainer extends over the open upper side of the container and the outer side of the closing member.

In an embodiment, the retainer comprises a slit which extends lengthwise of the elongate strip, wherein the slit extends at least from a central portion of the elongate strip all the way to the first end of the elongate strip, wherein a stem of the plant extends through the slit at the central portion, the slit being configured to allow the retainer to be removed from the housing by pulling the second end of the elongate strip.

The words “to the first end of the elongate strip” have a broad meaning. The slit may be open at said first end, the slit being configured to allow the retainer to be removed from the housing by pulling the second, opposite end of the elongate strip. The slit may also extend lengthwise of the elongate strip, wherein the slit does not extend all the way to the first end of the elongate strip, but stops just before the end. In this embodiment the user has to tear a piece of the end off in order to obtain the required opening. This embodiment is also covered by the words “to the first end of the elongate strip”.

In an embodiment, the closing member and the container are integrally connected.

The invention further relates to a removable retainer configured to keep a growing medium in the container during transport, wherein the removable retainer comprises:
an elongate strip comprising a first end portion with a first end and a second end portion with a second end,
a central portion which is wider than the end portions,
a slit which extends lengthwise of the elongate strip, wherein the slit extends at least from a central portion of the elongate strip all the way to the first end of the elongate strip, the slit being open at said first end, allowing the retainer to be removed from the housing by pulling the second end of the elongate strip.

The central portion does not have to be wider than the end portions for the functionality, although it is the preferred embodiment.

In an embodiment, the slit of the removable retainer is wider at the central portion than at the first end portion in order to provide space for a stem of a plant to extend through the slit.

In an embodiment, the first end and the second end are provided with opening and closing means for connecting the first and second end to one another.

In an embodiment, the central portion comprises a resilient section configured to engage the growing medium in the container directly or indirectly and to bias the growing medium into the container.

In an embodiment, the resilient section comprises an inner part and outer parts connected to the inner part via first fold lines and being configured to be folded about said fold lines in order to protrude away from a plane defined by the inner part.

In an embodiment, each outer part comprises at least one second fold line provided at a distance d1 from the first fold line and at a distance d2 from an outer end of the outer part, wherein each outer part is folded about the second fold line.

The invention further relates to a method for assembling the plant terrarium assembly according to the present invention, the method comprising the steps:
a) moving the closing member of the transparent housing to the open position,
b) positioning the container, which holds a growing medium and at least one plant, on the inner side of the closing member,
c) placing the removable retainer over the container and around at least one stem of the plant,
d) moving the closing member relative to the housing to the closed position, thereby placing the housing over the closing member, the container and the removable retainer and positioning the first and second end portions of the retainer between the closing member and the rim.

In an embodiment of the method, the method comprises attaching a first end of the removable retainer to a second end, thereby closing the removable retainer.

In an embodiment of the method, prior to step c) outer parts of the removable retainer are folded about respective fold lines.

The invention further relates to a method for removing the removable retainer from the plant terrarium assembly according to any of the preceding claims, the method comprising the steps:
a) moving the closing member of the housing to the open position,
b) pulling the second end of the elongate strip until the removable retainer is out of the housing.
c) moving the closing member to the closed position.

In an embodiment of the method, prior to step a) or prior to step b) the removable retainer is opened by opening the opening and closing means.

### LIST OF FIGURES

The previous and other features and advantages of the present invention will be more fully understood from the following detailed description of exemplary embodiments with reference to the attached drawings. Like reference numerals refer to like parts.

FIG. 1A shows an isometric view of the plant terrarium assembly according to the invention.

FIG. 1B shows an isometric view of a detail of an embodiment of the plant terrarium assembly.

FIG. 1C shows a top view of a detail of an embodiment of the plant terrarium assembly.

FIG. 2 shows an isometric view of a assembling step of the plant terrarium assembly.

FIG. 3 shows an isometric view of another assembling step of the plant terrarium assembly.

FIG. 4 shows an isometric view of another assembling step of the plant terrarium assembly.

FIG. 5 shows an isometric view of another assembling step of the plant terrarium assembly.

FIG. 6A shows an isometric view of another embodiment of the plant terrarium assembly.

FIG. 6B shows a side view of the embodiment of FIG. 6A.

FIG. 7 shows an isometric view of yet another embodiment of the plant terrarium assembly.

FIG. 8 shows an isometric view of a step of removing the removable retainer.

FIG. 9 shows an isometric view of another step of removing the removable retainer.

FIG. 10 shows an isometric view of yet another step of removing the removable retainer.

FIG. 11 shows an isometric view of the plant terrarium assembly after removal of the removable retainer.

### DETAILED DESCRIPTION OF THE FIGURES

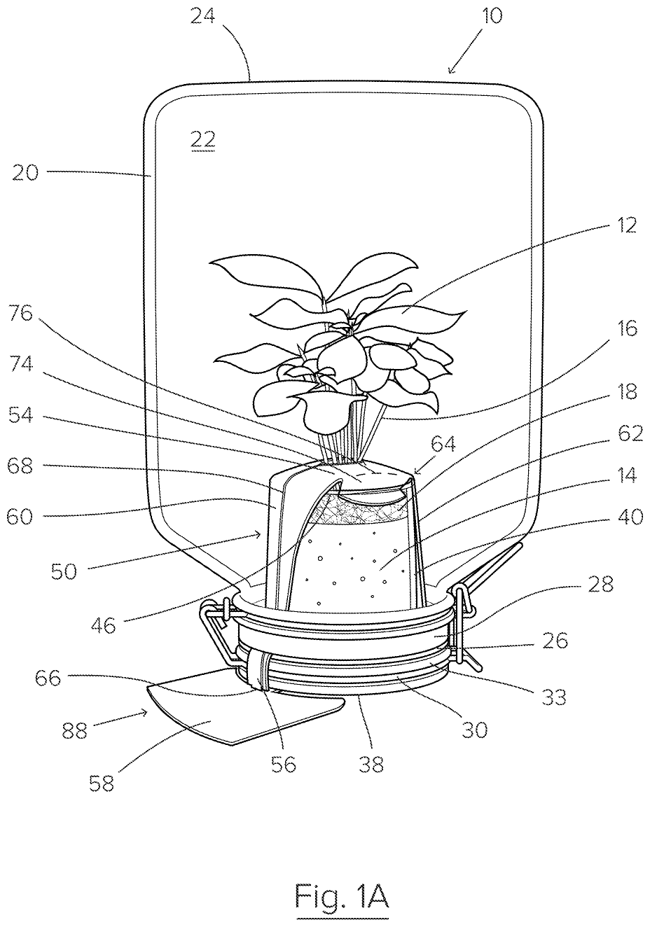

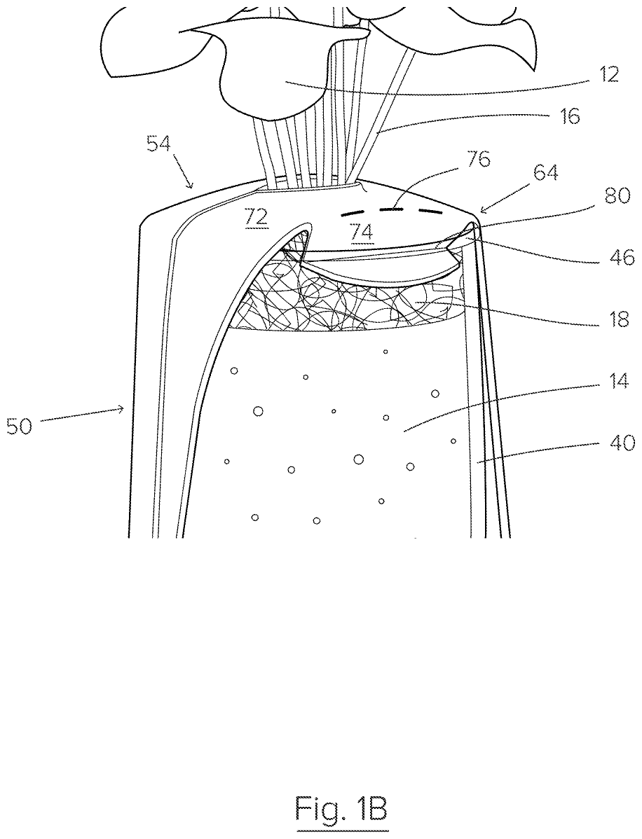

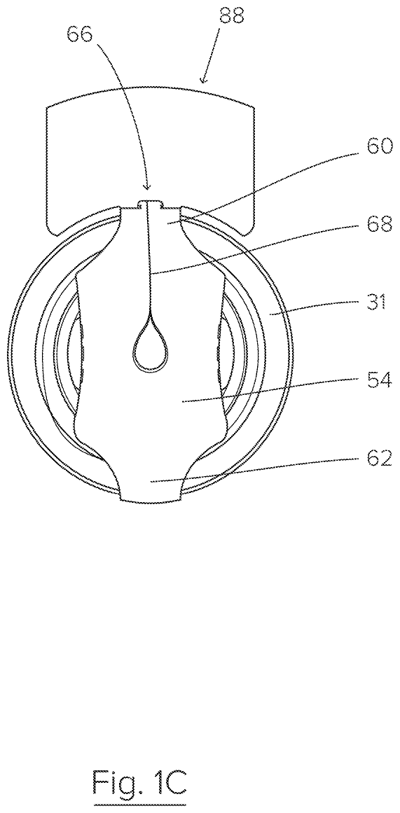

Turning to FIG. 1A, the plant terrarium assembly 10 according to the invention is shown. An at least partially transparent housing 20 encloses an inner volume 22. The housing may be made from glass, plastic, or other rigid transparent material. In a preferred embodiment the housing is essentially a jar. The housing may be circular when viewed in top view but obviously other shapes are also possible. The housing has a top side 24, as well as an opening 26 defined by a rim 28.

The plant is not intended to be removed from the housing. On the contrary, the housing is meant to create an airtight, enclosed ecosystem. This airtight, enclosed ecosystem requires no further care with respect to the plant 12. The plant is able to stay alive without nurturing. In other words, the plant requires no or only limited adding of water or nutrients. The plant reuses water that condenses on the inside of the housing and uses nutrients which are provided in the growing medium during manufacturing.

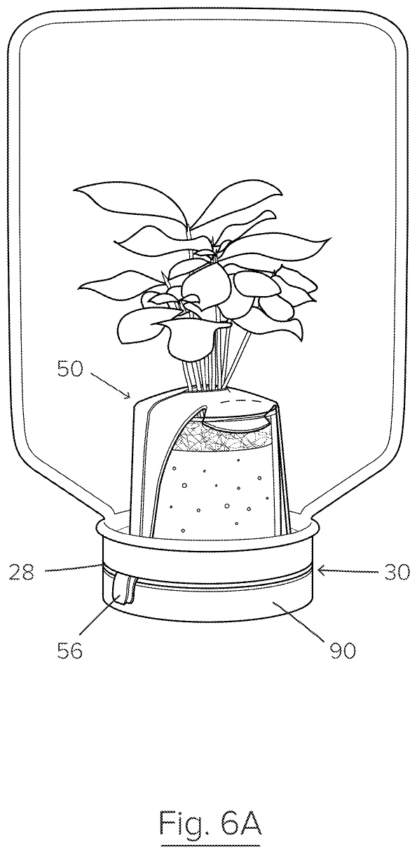

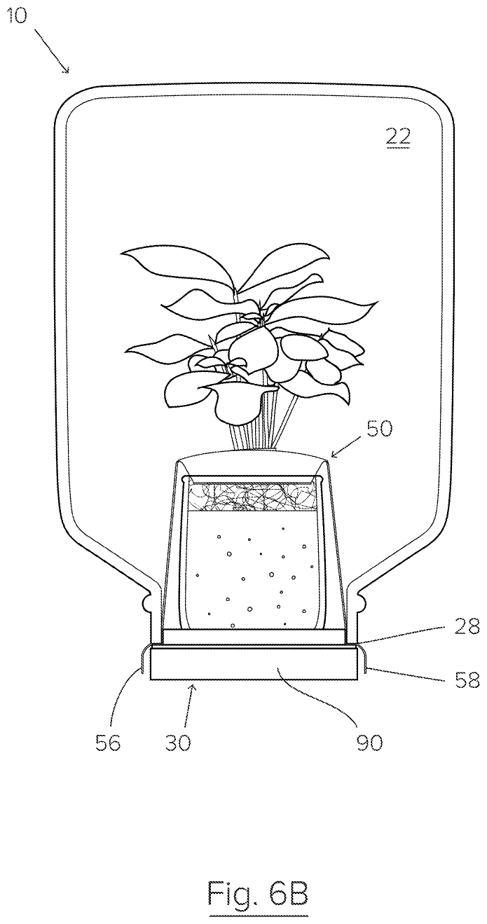

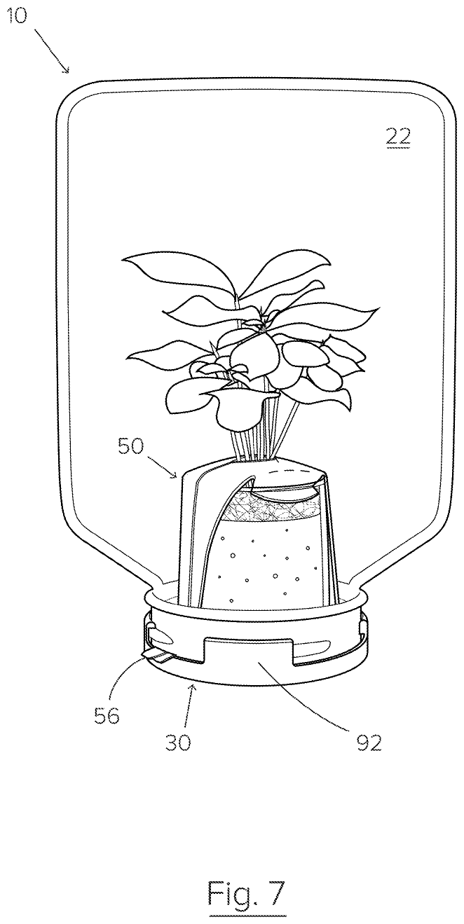

A closing member 30 is provided at the opening 26 of the housing 20 and has an inner side 31 and an outer side. The outer side of the closing member is also the bottom side 38 of the plant terrarium assembly. The bottom side 38 is generally placed on a base surface such as a table or simply a ground surface. It is also possible to hang the plant terrarium assembly from for example a ceiling. The closing member 30 can be a lid connected to the rest of the jar via a hinge. It may also be a screwcap 90 or a bayonet fitting 92, as shown in FIGS. 6A and 7, respectively. In the screwcap case the closing member has inner thread configured to be screwed on outer thread of an opening of the housing.

The closing member can move between a closed position and an open position. This leads to respective closing and opening of the housing. In the closed position the inner side 31 faces the inner volume 22.

A container 40 is provided on and supported by the inner side 31 of the closing member 30. The container has a closed lower end 42 and an open upper end 44. The closed lower end is attached to the inner side 31. The container may also be integrated with the closing member.

The container may be attached to the inner side with an adhesive, but may also stand on the inner side without any connections other than the retainer which is discussed further below.

The container has a circular shape when viewed in top view. However other shapes may obviously also be used.

A growing medium 14 and at least one plant 12 are positioned in the container 40. A body of fibrous material 18 may be added on top of the growing medium in order to better retain the growing medium in the container. The body of fibrous material may be a non-woven material, such as coconut fibre, felt, foam or horse hair.

A removable retainer 50 is provided in order to keep the growing medium in the container during transport. The removable retainer 50 is intended to be removed after transport. In case the container and the closing member are not integrated, the removable retainer also maintains the container in position relative to the housing during transport.

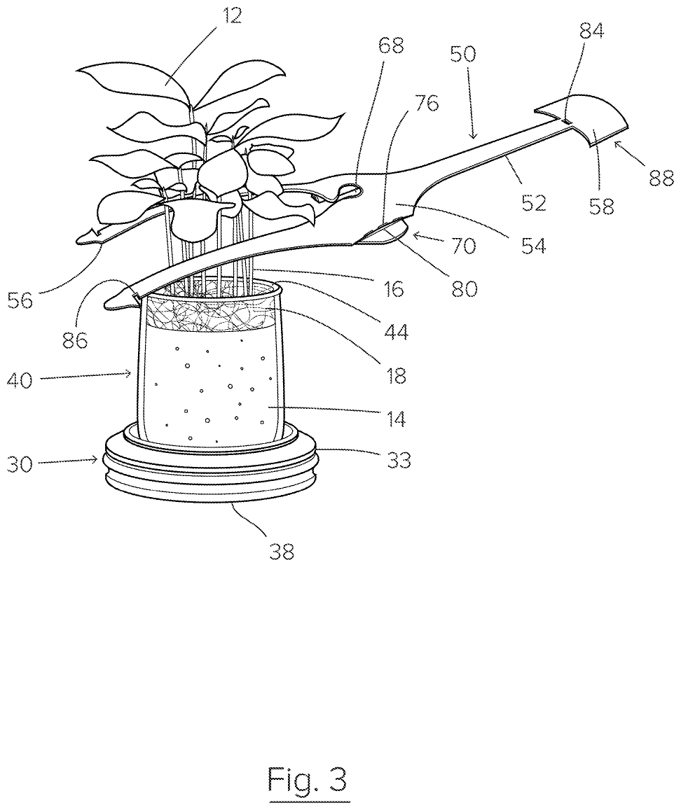

Turning to FIGS. 1B and 3, the removable retainer 50 is shown during installation. The removable retainer is an elongate strip 52 of a flexible material, in particular paper, cardboard or a plastic material. Other materials may also be possible. It is designed such that it can be easily removed, without damaging the plant.

A central portion 54 of the elongate strip 52 extends over the open upper end 44 of the container 40. The central portion is wider than the first and second opposite end portions 60, 62, as shown in top view in FIG. 1C. The central portion has folded portions which extend into the open upper end of the container and engage the non-woven material in order to keep the body of fibrous material and the growing medium in place.

The elongate strip further has opposite first and second ends 56, 58 which extend to outside the housing. In another embodiment it is also possible that the first and second ends 56, 58 do not extend to outside the housing, but extend up to the rim 28 of the transparent housing 20.

The second end may comprise a pulling section 88 configured to be pulled by a user.

Turning again to FIG. 1A, in both of the two above described embodiments the opposite first and second end portions 60, 62 of the elongate strip are wedged between the closing member which is in the closed position, and the housing. The wedging prevents the retainer 50 from moving. An extra effect of the wedging is the tensioning of the first and second end portions. Due to the extra tension a tighter fit of the removable retainer 50 over the container 40 is obtained. In other words, closing the closing member causes tension in the removable retainer.

The removable retainer 50 may have a first length L1 which is at least equal to the diameter D1 of the container plus twice the distance from a first edge 33 of the closing member, to a second edge 46 of the open upper and of the container. The first length L1 corresponds with the embodiment wherein the first and second ends 56, 58 only extend up to the rim 28 of the transparent housing.

In a preferred embodiment the removable retainer has a second length L2 which is at least equal to the diameter D1 of the container plus the diameter D2 of the closing member plus twice the distance from a first edge of the closing member, to a second edge 46 of the open upper end of the container. The removable retainer then extends over the open upper side of the container and the outer side of the closing member.

In case of a circular opening or a circular closing member, the diameter (D1) or diameter (D2) will be the diameter of the circle. In case of an opening or closing member of a different shape, the diameter will be the distance measured along a straight line which extends from one side of the opening or closing member to another side of the opening or closing member through the center of the opening or the center of the closing member.

In the above-mentioned preferred embodiment the first and second ends 56, 58 have an opening and closing means 66. The opening and closing means 66 attach the first and second ends 56, 58 of the retainer to one another. The opening 84 is configured to mate with the mating part 86. Opening and closing of the retainer is done outside the housing. Closing the retainer provides extra security during transport.

The removable retainer 50 according to the invention is configured keep a growing medium 14 in a container 40 during transport. It may also maintain the container in position relative to a housing of a plant terrarium assembly 10 during transport. Therefore, it may have a double function.

The removable retainer is an elongate strip 52 with a first end portion 60 with a first end 56 and a second end portion 62 with a second end 58. The retainer thus has a central portion 54 which is wider than at least one end portion.

The retainer further has a slit 68 which extends lengthwise of the elongate strip, wherein the slit 68 extends at least from a central portion 54 of the elongate strip all the way to the first end 56 of the elongate strip. The slit is open at said first end, allowing the retainer to be removed from the housing by pulling the second end of the elongate strip.

A stem 16 of the plant 12 extends through the slit at the central portion. A widening in the slit at the central portion may be provided at the location where the stem extends through the slit. Thus the slit is wider at the central portion than at the first end portion in order to provide space for the stem 16 of at least one plant 12. This will cause the least amount of damage for the stem.

Turning to FIG. 1B, a detail of the removable retainer is shown. The central portion 54 of the removable retainer has a resilient section 70. The resilient section engages the growing medium and biases the growing medium into the container. A body of fibrous material 18 may be provided between the growing medium and the resilient section.

The resilient section is made up of an inner part 72 and outer parts 74. The outer parts 74 are connected to the inner part via first fold lines 76. The outer parts are configured to be folded about said fold lines. In this way the outer parts protrude away from a plane defined by the inner part.

Each outer part 74 may have at least one second fold line 80 provided at a first distance dl from the respective first fold line 76 and at a second distance d2 from an outer end 82 of the outer part. Each outer part is folded about the second fold line.

### Operation

Turning to FIGS. 1A and FIGS. 2-5, the method of assembling the plant terrarium assembly 10 is shown. FIG. 1A shows the final stage, wherein the removable retainer 50 is provided. The assembling starts with just an at least partially transparent housing 20, in particular a jar with a closing member.

The first step of assembling the plant terrarium assembly is moving the closing member 30 to the open position, such that the closing member is decoupled from the transparent housing 20. So the closing member is apart from the housing.

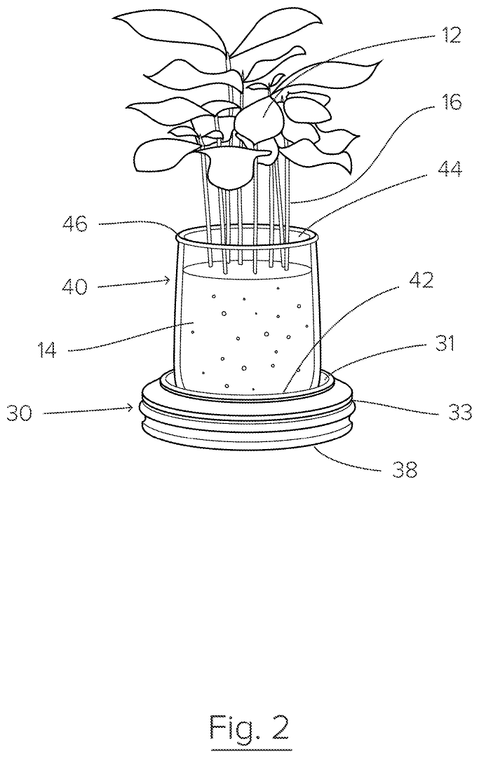

FIG. 2 shows the next step, wherein the container 40, which holds a growing medium 14 and at least one plant 12, is positioned on the inner side 31 of the closing member. A non-woven material 18 may also be provided on top of the growing medium and around the stem of the at least one plant. The non-woven material is shown in FIG. 3.

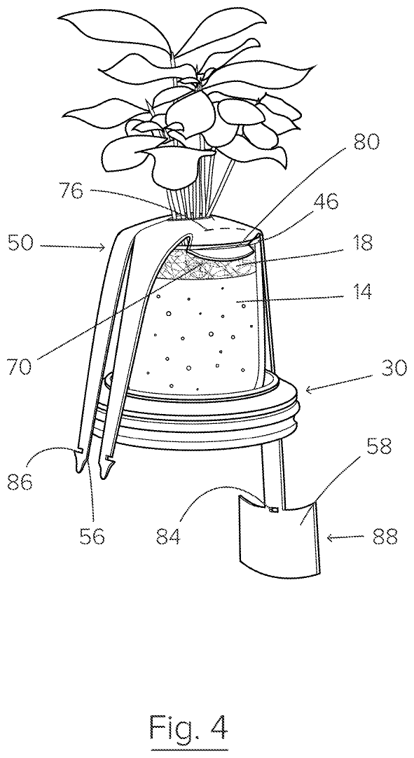

FIGS. 3 and 4 show the following step, wherein the removable retainer 50 is placed over the container 40 and around at least one stem 16 of the plant. This is facilitated by the slit of the removable retainer, which provides space for the stem.

Prior to the above-mentioned step, the outer parts 74 of the removable retainer may be folded about respective fold lines 76, 80. The folding creates a resilient section 70 that biases the growing medium and non-woven material into the container.

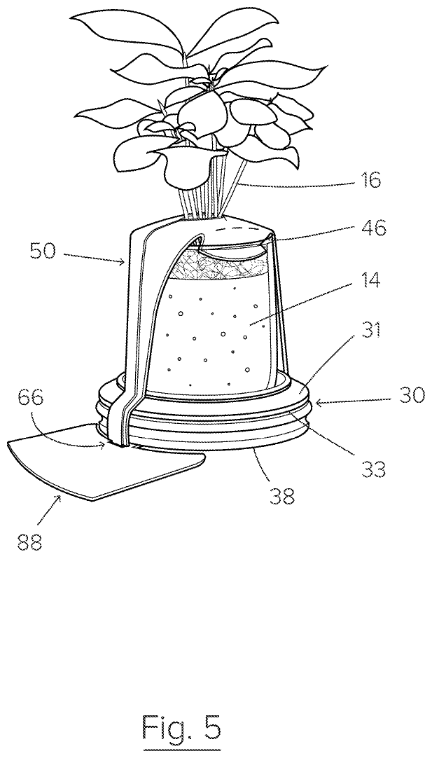

FIG. 5 shows the step wherein the removable retainer is closed with the opening and closing means 66. If a retainer without opening and closing means is used, the person skilled in the art will understand that this step is skipped.

The final step is moving the closing member relative to the housing to the closed position, thereby placing the housing over the closing member, the container and the removable retainer, and positioning the first and second end portions 60, 62 of the retainer between the closing member and the rim 28.

As the rim acts on the end portions 60, 62, the end portions experience tension. This tension is transferred to the central portion 54. This results in a tighter fit of the removable retainer over the container 40.

FIGS. 1, 6A, 6B and 7 show the assembled plant terrarium assembly with different embodiments of the removable retainer. FIG. 1 particularly shows the preferred embodiment with a retainer with opening and closing means 66.

FIGS. 6A and 6B show an embodiment wherein the closing member is a screwcap 90. The removable retainer does not have an opening and closing means. It is restricted due to the wedging between the rim 28 of the housing and the screwcap.

FIG. 7 shows another embodiment, wherein the removable retainer is restricted due to the wedging between the rim and the closing member. FIG. 7 shows in particular an embodiment with a bayonet fitting 92. Other couplings are also possible.

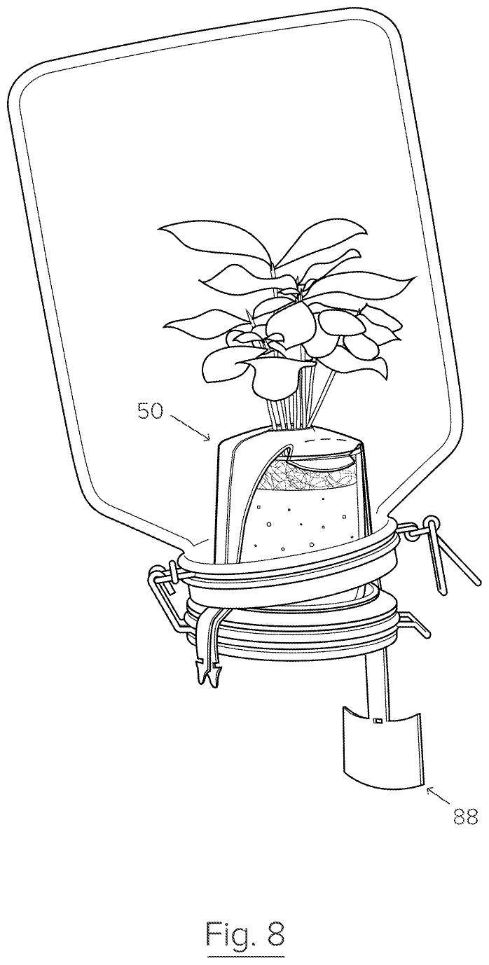

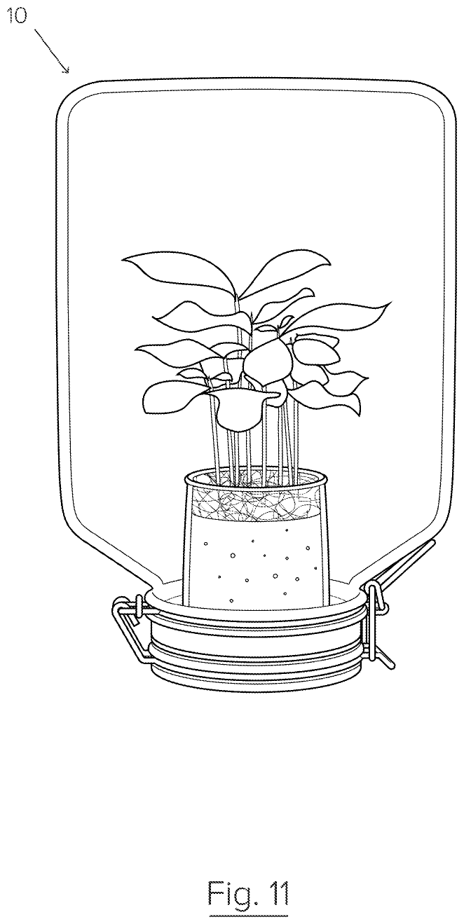

Turning to FIGS. 8-11, the method of removing the removable retainer is shown, wherein FIG. 11 shows the final step. That is the product as intended to be used by a customer, after transport.

FIG. 8 shows the first step. In case of a removable retainer with opening and closing means 66, a step is added. The added step is opening the removable retainer with the opening and closing means. After opening the retainer, the closing member is moved to its open position. The shown embodiment in FIG. 8 has a closing member that is connected via a hinge. In this case the housing is pivoted relative to the closing member. In case of a screwcap 90 or bayonet fitting 92, the closing member can be decoupled in its entirety.

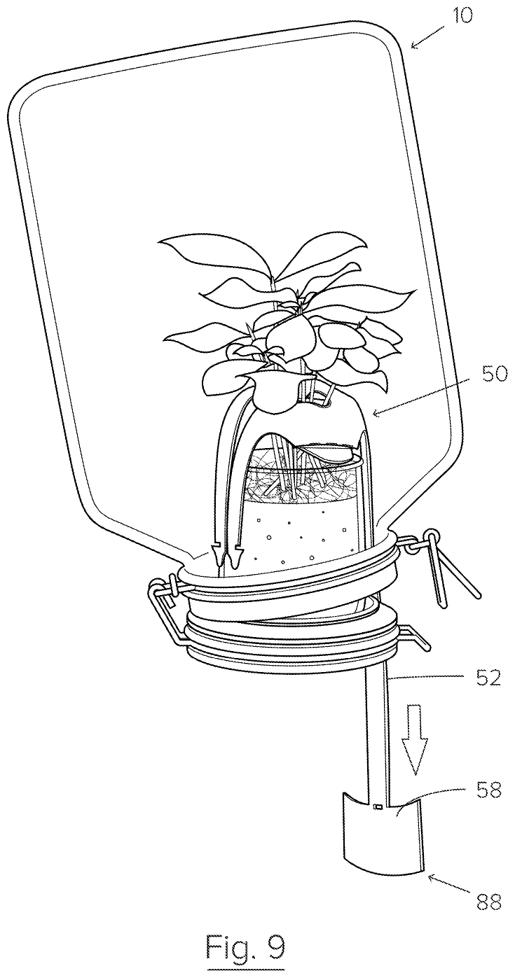

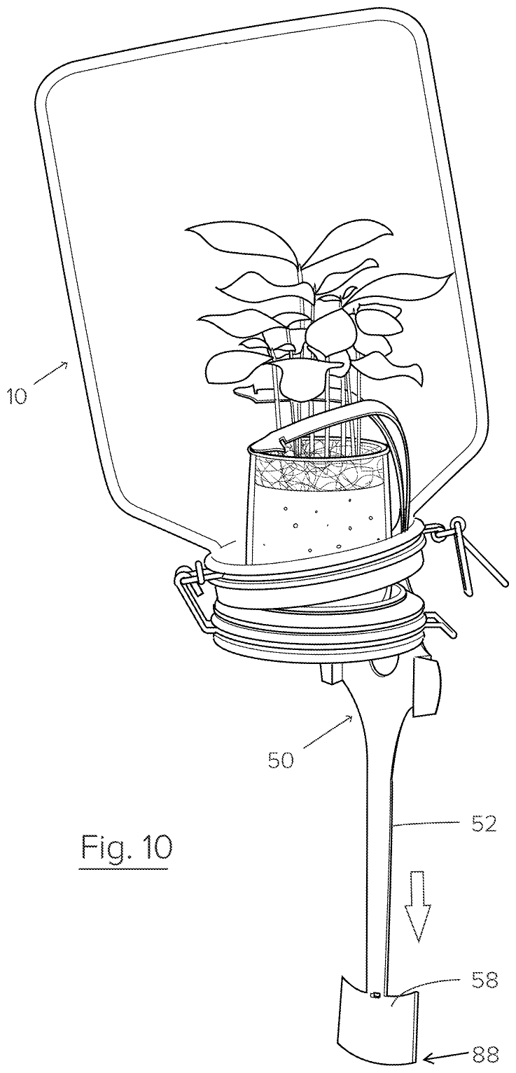

The next step is shown in FIGS. 9 and 10. The second end 58 of the elongate strip 52 is pulled, in particular downwards in the direction of the arrow. The slit widens as it is pulled past the stem. This prevents damaging the plant. The second end is pulled until the removable retainer 50 is completely removed from the housing and the closing member.

The final step is shown in FIG. 11, wherein the removable retainer is removed and the closing member is moved to the closed position, thereby providing again an airtight enclosed space.

It will be obvious to a person skilled in the art that the details and the arrangement of the parts may be varied over considerable range without departing from the scope of the claims.

The present invention further relates to the following numbered clauses.

1. Plant terrarium assembly 10 comprising:
an at least partly transparent housing 20 enclosing an inner volume 22, the at least partly transparent housing comprising a top side 24, and an opening 26 defined by a rim 28,
a closing member 30 configured to be moved between a closed position and an open position in order to open and close the opening in the housing,
wherein the closing member has an inner side 31 and an outer side, wherein in the closed position 36 the inner side faces the inner volume, and wherein the outer side is configured to form a bottom side 38 of the plant terrarium assembly,
a container 40 comprising a lower end 42 and an open upper end 44, wherein the container is supported by the inner side of the closing member,
a growing medium 14 and at least one plant 12 which are positioned in the container,
a removable retainer 50 configured to keep the growing medium in the container during transport.

2. Plant terrarium assembly according to clause 1, wherein the removable retainer is an elongate strip 52 of a flexible material, in particular paper, cardboard or a plastic material.

3. Plant terrarium assembly according to clause 1 or 2, wherein a central portion 54 of the elongate strip extends over the open upper end of the container.

4. Plant terrarium assembly according to any of the preceding clauses, wherein opposite first and second ends 56, 58 of the elongate strip extend to outside the housing.

5. Plant terrarium assembly according to any of the preceding clauses, wherein opposite first and second end portions 60, 62 of the elongate strip are wedged between the closing member which is in the closed position and the housing.

6. Plant terrarium assembly according to any of the preceding clauses, wherein the removable retainer has a first length L1 which is at least equal to the diameter D1 of the container plus twice the distance from a first edge 33 of the closing member to a second edge 46 of the open upper end of the container.

7. Plant terrarium assembly according to any of the preceding clauses, wherein the removable retainer has a second length L2 which is at least equal to the diameter D1 of the container plus the diameter D2 of the closing member plus twice the distance from a first edge 33 of the closing member to a second edge 46 of the open upper end of the container.

8. Plant terrarium assembly according to any of clauses 3-7, wherein the central portion is wider than the first and second opposite end portions.

9. Plant terrarium assembly according to any of the preceding clauses 3-8, wherein the central portion comprises folded portions 64 which extend into the open upper end of the container and engage the growing medium in order to keep the growing medium in place.

10. Plant terrarium assembly according to any of the preceding clauses, wherein the closing member and the container are integrally connected.

11. Plant terrarium assembly according to any of the preceding clauses, wherein the removable retainer has an opening and closing means 66 at the first and second opposite ends, wherein the opening and closing means are configured to attach the ends of the retainer to one another outside the housing.

12. Plant terrarium assembly according to any of the preceding clauses, wherein the removable retainer extends over the open upper side of the container and the outer side of the closing member.

13. Plant terrarium assembly according to any of the preceding clauses, wherein the retainer comprises a slit 68 which extends lengthwise of the elongate strip, wherein the slit extends at least from a central portion 54 of the elongate strip to the first end of the elongate strip, wherein a stem 16 of the plant extends through the slit at the central portion, the slit being configured to allow the retainer to be removed from the housing by pulling the second end of the elongate strip.

14. Removable retainer 50 configured to keep the growing medium 14 in the container during transport, wherein the removable retainer comprises:
an elongate strip 52 comprising a first end portion 60 with a first end 56 and a second end portion 62 with a second end 58,
a central portion 54 which is wider than the end portions,
a slit 68 which extends lengthwise of the elongate strip, wherein the slit extends at least from a central portion of the elongate strip to the first end of the elongate strip.

15. Removable retainer according to clause 14, wherein the slit is open at said first end, allowing the retainer to be removed from the housing by pulling the second end of the elongate strip.

16. Removable retainer according to clause 14 or 15, wherein the slit is wider at the central portion than at the first end portion in order to provide space for a stem 16 of at least one plant 12 to extend through the slit.

17. Removable retainer according to any of clauses 14-16, wherein the first end and the second end are provided with opening and closing means 66 for connecting the first and second end to one another.

18. Removable retainer according to any of clauses 14-17, wherein the central portion comprises a resilient section 70 configured to engage the growing medium in the container and to bias the growing medium into the container.

19. Removable retainer according to clause 18, wherein the resilient section comprises an inner part 72 and outer parts 74 connected to the inner part via first fold lines 76 and being configured to be folded about said fold lines in order to protrude away from a plane 78 defined by the inner part.

20. Removable retainer according to the previous clause, wherein each outer part 74 comprises at least one second fold line 80 provided at a first distance d1 from the first fold line and at a second distance d2 from an outer end 82 of the outer part, wherein each outer part is folded about the second fold line.

21. Method for assembling the plant terrarium assembly 10 according to any of clauses 1-13, the method comprising the steps:
a. moving the closing member 30 of the transparent housing 20 to the open position, wherein the closing member is decoupled from the transparent housing,
b. positioning the container 40, which holds a growing medium 14 and at least one plant 12, on the inner side 31 of the closing member,
c. placing the removable retainer 50 over the container and around at least one stem 16 of the plant,
d. moving the closing member relative to the housing to the closed position, thereby placing the housing over the closing member, the container and the removable retainer, and positioning the first and second end portions 60, 62 of the retainer between the closing member and the rim 28.

22. Method according to the previous method clause, comprising attaching a first end 56 of the removable retainer to a second end 58, thereby closing the removable retainer.

23. Method according to any of the preceding method clauses, wherein prior to step c) outer parts 74 of the removable retainer are folded about respective fold lines 76, 80.

24. Method for removing the removable retainer from the plant terrarium assembly according to any of clauses 1-13, the method comprising the steps:
a. moving the closing member 30 of the housing 20 to the open position,
b. pulling the second end 58 of the elongate strip 52 until the removable retainer is out of the housing,
c. moving the closing member to the closed position.

25. The method according to the previous method clause, wherein prior to step a) or prior to step b) the removable retainer is opened by opening the opening and closing means 66.

1-25. (canceled)

26. A plant terrarium assembly comprising:
an at least partly transparent housing enclosing an inner volume, the at least partly transparent housing comprising a top side, and an opening defined by a rim,
a closing member configured to be moved between a closed position and an open position in order to open and close the opening in the housing, wherein the closing member has an inner side and an outer side, wherein in the closed position the inner side faces the inner volume, and wherein the outer side is configured to form a bottom side of the plant terrarium assembly,
a container comprising a lower end and an open upper end, wherein the container is supported by the inner side of the closing member,
a growing medium and at least one plant which are positioned in the container, wherein the at least partly transparent housing is positioned over the container, the growing medium and the plant, and wherein the container, the growing medium and the plant are inside the at least partly transparent housing, and a removable retainer configured to keep the growing medium in the container during transport, wherein the removable retainer has a first length (L1) which is at least equal to the diameter (D1) of the container plus twice the distance from a first edge of the closing member to a second edge of the open upper end of the container.

27. The plant terrarium assembly according to claim 26, wherein the removable retainer is an elongate strip of a flexible material, in particular paper, cardboard or a plastic material, and wherein opposite first and second end portions of the elongate strip are wedged between the closing member which is in the closed position and the housing.

28. The plant terrarium assembly according to claim 26, wherein the plant terrarium assembly is configured to be an airtight, enclosed ecosystem.

29. The plant terrarium assembly according to claim 26, wherein a central portion of the elongate strip extends over the open upper end of the container.

30. The plant terrarium assembly according to claim 26, wherein opposite first and second ends of the elongate strip extend to outside the housing.

31. The plant terrarium assembly according to claim 26, wherein the removable retainer has a second length (L2) which is at least equal to the diameter (D1) of the container plus the diameter (D2) of the closing member plus twice the distance from a first edge of the closing member to a second edge of the open upper end of the container.

32. The plant terrarium assembly according to claim 29, wherein the central portion is wider than the first and second opposite end portions.

33. The plant terrarium assembly according to claim 29, wherein the central portion comprises folded portions which extend into the open upper end of the container and engage the growing medium in order to keep the growing medium in place.

34. The plant terrarium assembly according to claim 26, wherein the closing member and the container are integrally connected.

35. The plant terrarium assembly according to claim 26, wherein the removable retainer has an opening and closing means at the first and second opposite ends, wherein the opening and closing means are configured to attach the ends of the retainer to one another outside the housing.

36. The plant terrarium assembly according to claim 26, wherein the removable retainer extends over the open upper side of the container and the outer side of the closing member.

37. The plant terrarium assembly according to claim 26, wherein the retainer comprises a slit which extends lengthwise of the elongate strip, wherein the slit extends at least from a central portion of the elongate strip to the first end of the elongate strip, wherein a stem of the plant extends through the slit at the central portion, the slit being configured to allow the retainer to be removed from the housing by pulling the second end of the elongate strip.

38. A removable retainer configured and intended to be used in the plant terrarium assembly according to claim 26, and configured to keep the growing medium in the container during transport, wherein the removable retainer comprises:
an elongate strip comprising a first end portion with a first end and a second end portion with a second end,
a central portion which is wider than the end portions, and
a slit which extends lengthwise of the elongate strip, wherein the slit extends at least from a central portion of the elongate strip to the first end of the elongate strip.

39. The removable retainer according to claim 38, wherein the slit is open at said first end, allowing the retainer to be removed from the housing by pulling the second end of the elongate strip.

40. The removable retainer according to claim 38, wherein the slit is wider at the central portion than at the first end portion in order to provide space for a stem of at least one plant to extend through the slit.

41. The removable retainer according to claim 38, wherein the first end and the second end are provided with opening and closing means for connecting the first and second end to one another.

42. The removable retainer according to any of claim 38, wherein the central portion comprises a resilient section configured to engage the growing medium in the container and to bias the growing medium into the container.

43. The removable retainer according to claim 42, wherein the resilient section comprises an inner part and outer parts connected to the inner part via first fold lines and being configured to be folded about said fold lines in order to protrude away from a plane defined by the inner part.

44. A method for assembling the plant terrarium assembly according to claim 26, the method comprising the steps:
a. moving the closing member of the transparent housing to the open position, wherein the closing member is decoupled from the transparent housing,
b. positioning the container, which holds a growing medium and at least one plant, on the inner side of the closing member,
c. placing the removable retainer over the container and around at least one stem of the plant, and
d. moving the closing member relative to the housing to the closed position, thereby placing the housing over the closing member, the container and the removable retainer, and positioning the first and second end portions of the retainer between the closing member and the rim.

45. The method according to claim 44, further comprising attaching a first end of the removable retainer to a second end, thereby closing the removable retainer.
